(19) United States
(12) Patent Application Publication
(10) Pub. No.: US 2015/0074649 A1
(43) Pub. Date: Mar. 12, 2015

(54) TECHNIQUES FOR TESTING APPLICATIONS

(71) Applicant: SAMSUNG SDS CO., LTD., Seoul (KR)

(72) Inventors: Kwang-Jae LEE, Ansan City (KR); Jae-Min SONG, Sungnam City (KR); Eun-Gu KWON, Seoul (KR); Tae-Hyung KIM, Seoul (KR); Ji-Seon LEE, Seongnamsi (KR)

(73) Assignee: SAMSUNG SDS CO., LTD., Seoul (KR)

(21) Appl. No.: 14/480,163

(22) Filed: Sep. 8, 2014

(30) Foreign Application Priority Data
Sep. 9, 2013 (KR) 10-2013-0108010

(51) Int. Cl. G06F 11/36; H04L 29/08

(52) U.S. Cl. CPC G06F 11/3672; H04L 67/02
USPC 717/124

(57) ABSTRACT

There is provided a method of testing an application. The method is performed by a client terminal device and includes: receiving, from a master terminal device, a test case including a code for testing the application, the code being written in a script including Javascript; in response to receiving, from the master terminal device, a request for executing the code in a unit of function or line, performing the execution of the code to test the application; and transmitting, to the master terminal device, a result of testing the application in accordance with the execution of the code.

### CROSS-REFERENCE TO RELATED APPLICATION

This application claims priority to and the benefit of Korean Patent Application No. 2013-0108010, filed on Sep. 9, 2013, the disclosure of which is incorporated herein by reference in its entirety.

### BACKGROUND

1. Field

The present disclosure relates to a technique for testing an application, and more particularly, to a technique for dynamically loading, into a device having a web browser-based application, a code which is written in a script and executing the code to test the application.

2. Discussion of Related Art

Many conventional computing environments are based on a personal computer (PC). Recently, however, computing environments have been implemented in a variety of devices such as a smartphone, a TV, and a refrigerator. These recent computing environments allow a web-based application to be executed on various types of devices.

Application compatibility should be considered in development of an application executable in several types of devices and/or various operating systems (OSs) used in the respective devices. In this regard, several OSs (e.g., iOS from Apple Inc., and Android from Google Inc.) for mobile devices such as a smartphone support development of a hybrid type application. Such a hybrid type application may be executed based on a web browser embedded in a mobile device, and, to this end, may be implemented to use highly-compatible, standard web technologies and particular or OS-native functions provided by the OS.

When an application is required to be executed in various computing environments based on different devices and/or OSs, there is a need to test the application for each environment. For an application which is executed based on a conventional PC web browser, the web browser may read a web page including a script and/or a user interface (UI), and then the runtime script and/or data read by the web browser may be controlled in a debug console of the web browser. However, since an existing web browser for a mobile device does not offer a remote debugging function, debugging a web browser-based application in the mobile device employs a different UI or a log message provided from an OS of the mobile device.

### SUMMARY

It may be cumbersome to debug a web-based application or a hybrid type application of a mobile device to test the application, in a manner similar to that described above. In particular, it takes significant time and cost to develop a different UI or a test code for the debugging and to use the UI and the test code for the testing of the application.

Further, for a conventional web automation test framework, there is a demand for writing a script other than a script (e.g., Javascript) that may be easily understood by an application developer, and, therefore, additional time and cost is required for the writing and interpretation of that script.

In addition, when the web/hybrid application is tested, the mobile device including the application may be connected to a development computer, but usually this connection may be one-to-one. In other words, it is in practice impossible to connect several mobile devices to the development computer in a concurrent manner to perform testing of applications. Therefore, it also takes considerable time and effort to integrate the test results for the several mobile devices.

Disclosed embodiments relate to a framework for dynamically loading, into a terminal device to be tested, a code (for example, a Javascript code) available to an application which may be based on various web browsers and executing the code to test the terminal device with the code and obtain a result of the test. In accordance with such a test framework, it is possible: to send, to at least one terminal device on which a web browser-based application is executed, a test case including a code written in a script; to request the terminal device to execute the code in a unit of function or line; and to receive, from the terminal device, a result of the execution.

According to an exemplary embodiment, there is provided a method of testing an application, the method being performed by a client terminal device and including: receiving, from a master terminal device, a test case including a code for testing the application, the code being written in a script including Javascript; in response to receiving, from the master terminal device, a request for executing the code in a unit of function or line, performing the execution of the code to test the application; and transmitting, to the master terminal device, a result of testing the application in accordance with the execution of the code.

A web browser of the client terminal device may be used to execute the application, and the script may be compatible with the web browser of the client terminal device and with another web browser having a type different from the web browser of the client terminal device.

The method may further include accessing a server device prior to receiving the test case, and the receiving of the test case, the receiving of the request, and the transmitting of the result may be relayed by the server device.

According to an exemplary embodiment, there is provided a communication method for an application test procedure, including: receiving, from a master terminal device, a test case that is associated with one or a plurality of client terminal devices and includes a code for testing an application included in each of said one or plurality of client terminal devices, the code being written in a script including Javascript; transmitting the test case to each of said one or plurality of client terminal devices; receiving, from the master terminal device, a request for executing the code in a unit of function or line; transmitting the request to each of said one or plurality of client terminal devices; receiving, from each of said one or plurality of client terminal devices, a result of testing the application in accordance with the execution of the code; and transmitting the result to the master terminal device.

A web browser of each of said one or plurality of client terminal devices may be used to execute the application, and the script may be compatible with a set of different types of web browsers including the web browser of each of said one or plurality of client terminal devices.

According to an exemplary embodiment, there is provided a computer-readable storage medium having computer executable instructions stored thereon which, when executed by a client terminal device, perform a method of testing an application, the method including: receiving, from a master terminal device, a test case including a code for testing the application, the code being written in a script including Javascript; in response to receiving, from the master terminal device, a request for executing the code in a unit of function or line, performing the execution of the code to test the application; and transmitting, to the master terminal device, a result of testing the application in accordance with the execution of the code.

According to an exemplary embodiment, there is provided a computer-readable storage medium having computer executable instructions stored thereon which, when executed, perform a communication method for an application test procedure, the communication method including: receiving, from a master terminal device, a test case that is associated with one or a plurality of client terminal devices and includes a code for testing an application included in each of said one or plurality of client terminal devices, the code being written in a script including Javascript; transmitting the test case to each of said one or plurality of client terminal devices; receiving, from the master terminal device, a request for executing the code in a unit of function or line; transmitting the request to each of said one or plurality of client terminal devices; receiving, from each of said one or plurality of client terminal devices, a result of testing the application in accordance with the execution of the code; and transmitting the result to the master terminal device.

According to an exemplary embodiment, there is provided a server device, including: a remote command server module communicatively connected to respective remote command client modules of two or more terminal devices, wherein the two or more terminal devices include a master terminal device and one or a plurality of client terminal devices associated with an application, wherein each of said one or plurality of client terminal devices includes the application, wherein the remote command client module of each of said one or plurality of client terminal devices is activated as a client remote command client module, wherein the remote command client module of the master terminal device is activated as a master remote command client module, and wherein the remote command server module is configured to: receive, from the master remote command client module, a test case including a code for testing the application, the code being written in a script including Javascript; transmit the test case to the client remote command client module of each of said one or plurality of client terminal devices; receive, from the master remote command client module, a request for executing the code in a unit of function or line; transmit the request to the client remote command client module of each of said one or plurality of client terminal devices; receive, from the client remote command client module of each of said one or plurality of client terminal devices, a result of testing the application in accordance with the execution of the code; and transmit the result to the master remote command client module.

A web browser of each of said one or plurality of client terminal devices may be used to execute the application, and the script may be compatible with a set of different types of web browsers including the web browser of each of said one or plurality of client terminal devices.

### BRIEF DESCRIPTION OF THE DRAWINGS

The above and other objects, features, and advantages of the present disclosure will become more apparent to those familiar with this field from the following detailed description when taken in conjunction with the accompanying drawings, in which:

FIG. 1 illustrates a terminal device and a server device for use in an application test procedure according to an exemplary embodiment;

FIG. 2 illustrates an application test system according to an exemplary embodiment;

FIG. 3 illustrates a configuration of a remote command client module according to an exemplary embodiment; and

FIG. 4 is a flowchart illustrating operations performed in a remote command client module of a master terminal device and a remote command client module of a client terminal device according to an exemplary embodiment.

### DETAILED DESCRIPTION OF EXEMPLARY EMBODIMENTS

Hereinafter, detailed embodiments of the present disclosure will be described with reference to drawings. However, the embodiments are merely examples and are not to be construed as limiting the present disclosure.

Various details already understood by those familiar with this field will be omitted to avoid obscuring the gist of the present disclosure. Terminology described below is defined considering functions in the present disclosure and may vary according to a user's or operator's intention or usual practice. Thus, the meanings of the terminology should be interpreted based on the overall context of the present specification.

The spirit of the present disclosure is determined by the claims, and the following exemplary embodiments are provided only to efficiently describe the spirit of the present disclosure to those familiar with this field.

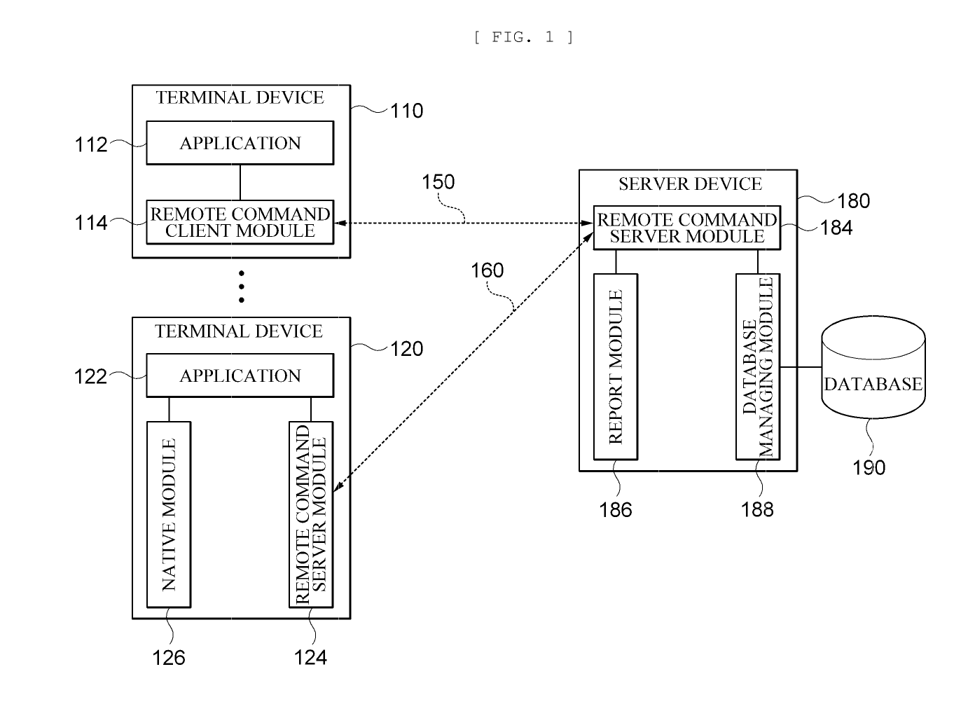

FIG. 1 illustrates a terminal device and a server device for use in an application test procedure according to an exemplary embodiment.

As illustrated in FIG. 1, an exemplary terminal device 110 includes an application 112 and a remote command client module 114. When the application 112 included in the terminal device 110 is to be tested, the remote command client module 114 may be added to the terminal device 110 to provide an environment for testing the application 112.

The application 112 may be a web application. The web application 112 may be executed using a web browser included in the terminal device 110. The web application 112 may be based on standard web technologies having high compatibility with different types of devices. For example, the web application 112 includes codes written in a language such as HyperText Markup Language (HTML), Cascading Style Sheets (CSS), and Javascript.

Another exemplary terminal device 120 includes an application 122 and a remote command client module 124. The remote command client module 124 is added to the terminal device 120 to provide an environment in which the application 122 may be tested.

The application 122 may be an application having a hybrid type. The hybrid web application 122 may use standard web technologies compatible with various web browsers and, in conjunction with a native module 126 for providing functions unique to an OS and/or a web browser embedded in the terminal device 120, may also use such functions.

In the foregoing, the two terminal devices 110 and 120 are briefly outlined. It can be understood that the number of the above-mentioned terminal devices is merely illustrative and does not serve to limit the number of terminal devices in disclosed embodiments.

In an application test environment, a server device 180 may be communicatively connected to the terminal devices 110 and 120, as denoted by dotted lines 150 and 160. In addition, the server device 180 may be communicatively connected to another terminal device having an identical or similar configuration to that of the terminal device 110 or that of the terminal device 120. For example, the terminal devices 110 and 120 may use a web browser compatible with Javascript and HTML5 supporting a WebSocket, and, based on the WebSocket, the respective remote command client modules 114 and 124 of the terminal devices 110 and 120 may be communicatively connected to a remote command server module 184 included in the server device 180.

The remote command server module 184 of the server device 180 manages access by a terminal device (for example, the terminal devices 110 and 120) to the server device 180, manages a terminal device participating in a test runner, i.e., an individual unit of progress for a test associated with a certain application, and relays a message between terminal devices participating in the test runner. The message relay may be performed in a peer-to-peer (P2P) manner or in a broadcast manner. In addition, the remote command server module 184 may set a terminal device as serving as a master terminal device or a client terminal device in the application test. Further description will be provided below regarding the master terminal device and the client terminal device.

The server device 180 may be connected to a database 190 having stored therein test cases each including a code written in a script and a parameter required for executing the code. The database 190 may be located outside of the server device 180 or may be integrated with the server device 180.

The code included in a test case is written in a script compatible with a set of different types of web browsers included in various types of terminal devices. For example, the script may include Javascript. Such a code written in a script (for example, Javascript) that is readily understandable by a developer may effectively perform a repetitive test on the application based on a control statement and the like. According to exemplary embodiments, the test case including the code may be associated with one or a plurality of client terminal devices, and may be used for testing the application included in the client terminal device(s). For this purpose, the test case may be provided to each of the one or plurality of client terminal devices from a master terminal device.

The server device 180 may further include a report module 186. The report module 186 is configured to gather a result of testing an application included in a client terminal device when a remote command client module of the client terminal device, which may be also referred to as a “client remote command client module,” executes a code include in a test case, and to generate a result report. The result report may reflect the test result received from the client terminal device(s) associated with the application.

The server device 180 may further include a database managing module 188 configured to manage the test cases of the database 190. For example, the database managing module 188 provides, to a remote command client module of a master terminal device, which may be also referred to as a “master remote command client module,” a test case selected from the database 190 in response to a request by the master remote command client module. In addition, the database managing module 188 is configured to perform an operation of adding a new test case to the database 190 or removing a certain test case from the database 190. Such an operation may be performed in response to an instruction from the master remote command client module. For example, after a portion of the test case provided to the master remote command client module is changed, the master remote command client module may deliver, to the database managing module 188, a message indicating that the changed test case is required to be added. In response to the message, the database managing module 188 may add the changed test case to the database 190.

FIG. 2 illustrates an application test system according to an exemplary embodiment.

As illustrate in FIG. 2, an exemplary application test system 200 includes a master terminal device 210, one or a plurality of client terminal devices 220, 230, and 240, and a server device 280.

The master terminal device 210 may have an identical or similar configuration to that of the terminal device 110 or 120. For example, the master terminal device 210 may include a remote command client module identical or similar to the remote command client modules 114 and 124. The client terminal devices 220, 230, and 240 may include the application 112 and the remote command client module 114 in a manner similar to the terminal device 110, or may include the application 122, the remote command client module 124, and the native module 126 in a manner similar to the terminal device 120. The server device 280 may have an identical or similar configuration to that of the server device 180 illustrated in FIG. 1.

The master remote command client module of the master terminal device 210 participates in a certain test runner and manages an application test procedure. The test runner may be associated with an application and the client terminal devices 220, 230, and 240 may participate in the test runner. In that case, the client terminal devices 220, 230, and 240 include the application. This application may be executed by using a web browser of each of the client terminal devices 220, 230, and 240. The master remote command client module is configured to obtain a test case (for example, from the server device 280 or from a user input including a modification of an existing test case provided from the server device 280), to transmit the test case to the client terminal devices 220, 230, and 240, to allow the client terminal devices 220, 230, and 240 to execute a code included in the test case for a test of the application, and to receive a result of the test.

Specifically, in order to manage the application test procedure, the master terminal device 210 may operate as follows. The following operations may be performed by the master remote command client module of the master terminal device 210.

The master terminal device 210 is associated with the one or plurality of client terminal devices 220, 230, and 240, and obtains a test case including a code written in a script for testing a same application included in each of the client terminal devices 220, 230, and 240. The script used to write the code is compatible with a web browser of each of the client terminal devices 220, 230, and 240. In particular, even when the web browser of at least one of the client devices 220, 230, 240 (for example, the client terminal device 220) has a different type as compared to the web browsers of other client terminal devices (for example, the client terminal devices 230 and 240), the script is compatible with the respective web browsers. For example, as described above, the script may include Javascript. Since Javascript is available in different types of devices and in various web browsers (for example, Safari from Apple Inc., and Chrome from Google Inc.), a separate analyzer for performing the test case of Javascript is not necessarily required.

The master terminal device 210 transmits the obtained test case to each of the client terminal devices 220, 230, and 240, and requests, from each of the client terminal devices 220, 230, and 240, execution of the code included in the test case. According to an exemplary embodiment, it may be requested that the code should be executed in a unit of function or line.

Further, after the application is tested in accordance with the execution of the code on the client terminal devices 220, 230, and 240, the master terminal device 210 receives, from each of the client terminal devices 220, 230, and 240, a result of the testing of the application.

The master terminal device 210 accesses the server device 280 to participate in a test runner through the server device 280, and the server device 280 relays the transmission of the test case, the requesting for the execution of the code, and the receipt of the test result.

The master remote command client module of the master terminal device 210 may be further configured to perform management such as the issuance and editing of a test runner, the addition, modification and/or deletion of a test case, etc. (for example, delivering, to the database managing module 188 of the server device 280, a message indicating that a modified test case should be added to the database 190 or that a certain test case should be deleted from the database 190), and to perform a request for a test result report (for example, requesting a test result report from the report module 186 of the server device 280).

The client remote command client module of each of the client terminal devices 220, 230, and 240 participates in a test runner identified by accessing the server device 280, and receives a test case from the master terminal device 210. The client remote command client module extracts a code from the received test case, executes the extracted code, and tests an application included in the client terminal devices 220, 230, and 240.

Specifically, in order to test the application included in the client terminal devices 220, 230, and 240, the client terminal devices 220, 230, and 240 may operate as follows. The following operations may be performed by the client remote command client module of each of the client terminal devices 220, 230, and 240.

Each of the client terminal devices 220, 230, and 240 receives, from the master terminal device 210, a test case including a code written in a script (for example, Javascript) for testing an application. As described above, since the script such as Javascript is compatible with a set of different types of web browsers, the script is compatible with a web browser of each of the client terminal devices 220, 230, and 240. In particular, even when the client terminal devices 220, 230, and 240 include different types of web browsers, the script is compatible with the respective web browsers.

In response to receiving, from the master terminal device 210, a request for executing the code, each of the client terminal devices 220, 230, and 240 extracts the code from the test case and executes the extracted code so as to test the application. When the request for executing the code includes a request for executing the code in a unit of function or line, the extracted code may be executed in a unit of function or line. Also, the extracted code may be executed without being mixed with the code of the application. The execution of the code extracted from the test case with the code of the application being kept intact may reduce the inconvenience of modifying the application for a test of the application and checking a result of the test.

Each of the client terminal devices 220, 230, and 240 transmits, to the master terminal device 210, a result of testing the application in accordance with the execution of the code.

The receipt of the test case, the receipt of the request for executing the code, and the transmission of the test result are relayed by the server device 280.

When the application test procedure is considered from a point of view of the server device 280, the server device 280 is configured to perform the following operations. The server device 280 is configured to: receive, from the master terminal device 210, a test case that is associated with the client terminal devices 220, 230, and 240 and includes a code written in a script for testing an application included in each of the client terminal devices 220, 230, and 240; transmit the received test case to each of the client terminal devices 220, 230, and 240; receive, from the master terminal device 210, the request for executing the code; transmit the received request to each of the client terminal devices 220, 230, and 240; receive, from each of the client terminal devices 220, 230, and 240, a result of testing the application in accordance with the execution of the code; and transmit the result to the master terminal device 210. These operations may be performed by the remote command server module (for example, the remote command server module 184) of the server device 280. As described above, the remote command server module of the server device 280 is communicatively connected to the master remote command client module and the client remote command client modules.

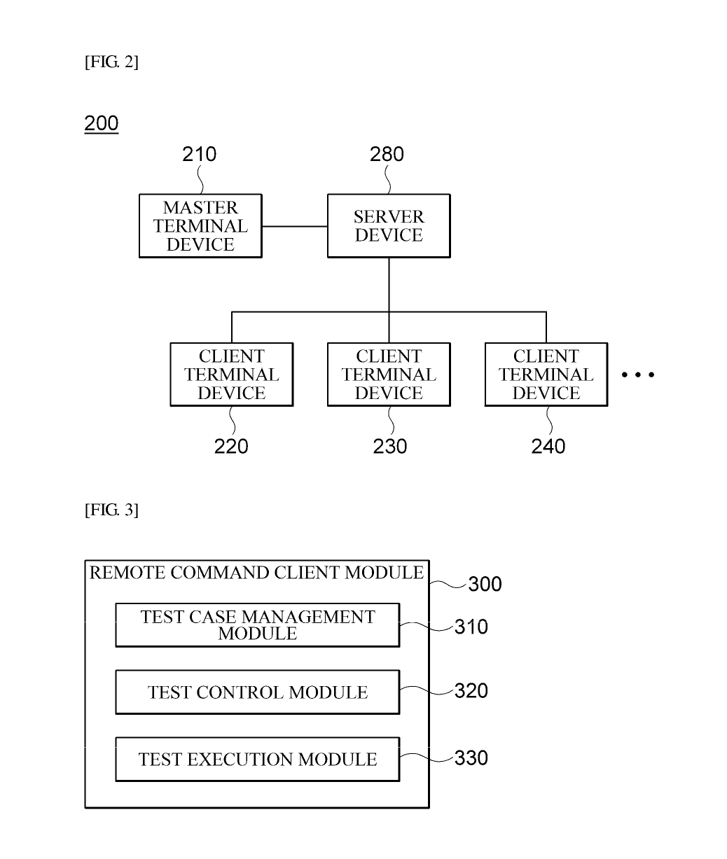

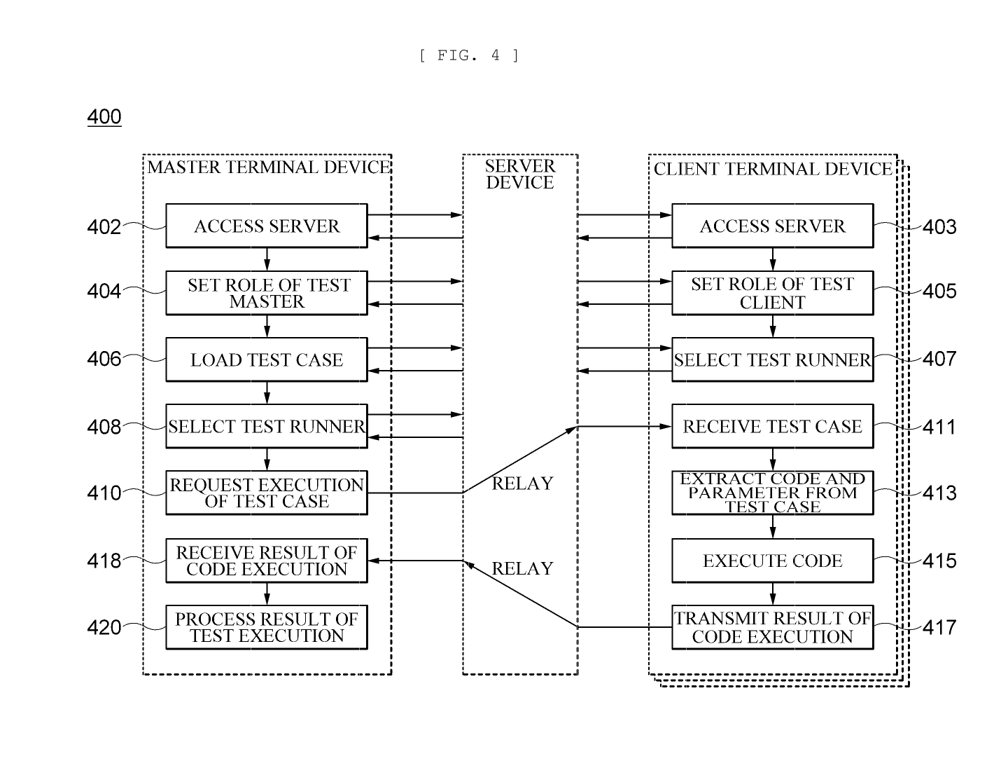

FIG. 3 illustrates a configuration of a remote command client module according to an exemplary embodiment.

As illustrated in FIG. 3, an exemplary remote command client module 300 includes a test case managing module 310, a test control module 320, and a test executing module 330.

The test case managing module 310 is configured to obtain a test case including a code written in a script for testing an application. The test control module 320 is configured to transmit the test case to a client remote command client module of a client terminal device (for example, the client terminal devices 220, 230, and 240), to request execution of the code, and to receive, from the client remote command client module, a result of testing the application in accordance with the execution of the code.

Meanwhile, the test executing module 330 is configured to receive, from a master remote command client module of a master terminal device (for example, the master terminal device 210), a test case including a code written in a script for testing an application, to execute the code in response to receiving, from the master remote command client module, a request for executing the code, and to transmit, to the master remote command client module, a result of testing the application in accordance with the execution of the code.

The test case management module 310, the test control module 320, and the test execution module 330 may be activated according to whether the terminal device including the remote command client module 300 is set as a master terminal device or a client terminal device.

For example, when the terminal device including the remote command client module 300 is set as a master terminal device, the test case management module 310 and the test control module 320 may be activated and it can be said that the remote command client module 300 is activated as a master remote command client module.

As another example, when the terminal device including the remote command client module 300 is set as a client terminal device, the test execution module 330 may be activated and it can be said that the remote command client module 300 is activated as a client remote command client module.

FIG. 4 is a flowchart illustrating operations performed in a remote command client module of a master terminal device and a remote command client module of a client terminal device according to an exemplary embodiment.

As illustrated in FIG. 4, in an exemplary process 400 of testing an application, a terminal device accesses a server device (operation 402) and then is set as a master terminal device for testing the application (operation 404), while another terminal device accesses the server device (operation 403) and then is set as a client terminal device for testing the application (operation 405).

The master terminal device loads a test case from the server device (operation 406), and selects a test runner associated with the application from the server (operation 408). The client terminal device also selects the test runner identifiable from the server (operation 407). The client terminal device includes the above-mentioned application.

The master terminal device transmits the test case to one or a plurality of client terminal devices participating in the test runner, and requests execution of the code included in the test case (operation 410). The test case and the request for the execution of the code are relayed by the server device and are received by each client terminal device (operation 411).

Each client terminal device extracts the code and a parameter from the received test case (operation 413), and executes the extracted code (operation 415). Each client terminal device transmits a result of testing the application by the execution of the code (operation 417). The test result is relayed by the server device and received by the master terminal device (operation 418). Then, the master terminal device processes the received test result (operation 420). For example, the master terminal device may output the test result in the form of a report.

According to exemplary embodiments, there is provided a framework for facilitating the testing of a web browser-based application on various devices and/or OSs and the integration of the test results.

According to exemplary embodiments, the code of an application and the code for testing the application are separate and, therefore, it is possible to test the application by executing the test code in real time without having to modify the application after the application is installed in a terminal device.

Meanwhile, an exemplary embodiment of the present disclosure can include a computer-readable storage medium including a program for performing the methods described herein on a computer. The computer-readable storage medium may separately include program commands, local data files, local data structures, etc. or include a combination of them. The computer-readable storage medium may be specially designed and configured for the present disclosure, or known and available to those of ordinary skill in the field of computer software. Examples of the computer-readable storage medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and execute program commands. Examples of the program commands may include high-level language codes executable by a computer using an interpreter, etc., as well as machine language codes made by compilers.

It will be apparent to those familiar with this field that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A method of testing an application, the method being performed by a client terminal device and comprising:
receiving, from a master terminal device, a test case including a code for testing the application, the code being written in a script including Javascript;
in response to receiving, from the master terminal device, a request for executing the code in a unit of function or line, performing the execution of the code to test the application; and
transmitting, to the master terminal device, a result of testing the application in accordance with the execution of the code.

2. The method of claim 1, wherein a web browser of the client terminal device is used to execute the application, and wherein the script is compatible with the web browser of the client terminal device and with another web browser having a type different from the web browser of the client terminal device.

3. The method of claim 1, further comprising accessing a server device prior to receiving the test case, wherein the receiving of the test case, the receiving of the request, and the transmitting of the result are relayed by the server device.

4. A communication method for an application test procedure, comprising:
receiving, from a master terminal device, a test case that is associated with one or a plurality of client terminal devices and includes a code for testing an application included in each of said one or plurality of client terminal devices, the code being written in a script including Javascript;
transmitting the test case to each of said one or plurality of client terminal devices;
receiving, from the master terminal device, a request for executing the code in a unit of function or line;
transmitting the request to each of said one or plurality of client terminal devices;
receiving, from each of said one or plurality of client terminal devices, a result of testing the application in accordance with the execution of the code; and
transmitting the result to the master terminal device.

5. The communication method of claim 4, wherein a web browser of each of said one or plurality of client terminal devices is used to execute the application, and wherein the script is compatible with a set of different types of web browsers including the web browser of each of said one or plurality of client terminal devices.

6. A computer-readable storage medium having computer executable instructions stored thereon which, when executed by a client terminal device, perform a method of testing an application, the method comprising:
receiving, from a master terminal device, a test case including a code for testing the application, the code being written in a script including Javascript;
in response to receiving, from the master terminal device, a request for executing the code in a unit of function or line, performing the execution of the code to test the application; and
transmitting, to the master terminal device, a result of testing the application in accordance with the execution of the code.

7. A computer-readable storage medium having computer executable instructions stored thereon which, when executed, perform a communication method for an application test procedure, the communication method comprising:
receiving, from a master terminal device, a test case that is associated with one or a plurality of client terminal devices and includes a code for testing an application included in each of said one or plurality of client terminal devices, the code being written in a script including Javascript;
transmitting the test case to each of said one or plurality of client terminal devices;
receiving, from the master terminal device, a request for executing the code in a unit of function or line;
transmitting the request to each of said one or plurality of client terminal devices;
receiving, from each of said one or plurality of client terminal devices, a result of testing the application in accordance with the execution of the code; and
transmitting the result to the master terminal device.

8. A server device, comprising:
a remote command server module communicatively connected to respective remote command client modules of two or more terminal devices,
wherein the two or more terminal devices include a master terminal device and one or a plurality of client terminal devices associated with an application, wherein each of said one or plurality of client terminal devices includes the application, wherein the remote command client module of each of said one or plurality of client terminal devices is activated as a client remote command client module, wherein the remote command client module of the master terminal device is activated as a master remote command client module, and wherein the remote command server module is configured to:
receive, from the master remote command client module, a test case including a code for testing the application, the code being written in a script including Javascript;
transmit the test case to the client remote command client module of each of said one or plurality of client terminal devices;
receive, from the master remote command client module, a request for executing the code in a unit of function or line;
transmit the request to the client remote command client module of each of said one or plurality of client terminal devices;
receive, from the client remote command client module of each of said one or plurality of client terminal devices, a result of testing the application in accordance with the execution of the code; and
transmit the result to the master remote command client module.

9. The server device of claim 8, wherein a web browser of each of said one or plurality of client terminal devices is used to execute the application, and wherein the script is compatible with a set of different types of web browsers including the web browser of each of said one or plurality of client terminal devices.
